(19) United States
(12) Patent Application Publication
(10) Pub. No.: US 2016/0253627 A1
(43) Pub. Date: Sep. 1, 2016

(54) SYSTEM AND METHOD FOR JOB SEACHING AND REFERRAL

(71) Applicant: KARMASUIT TECHNOLOGIES INC., Los Angeles, CA (US)

(72) Inventors: REZA DAWOOD, LOS ANGELES, CA (US); MISAK MELIKYAN, STUDIO CITY, CA (US); ZACHARY PEOPLES, MOUNTAIN VIEW, CA (US)

(21) Appl. No.: 15/051,553

(22) Filed: Feb. 23, 2016

Related U.S. Application Data
(60) Provisional application No. 62/121,855, filed on Feb. 27, 2015.

(51) Int. Cl. G06Q 10/10; G06F 17/30; G06Q 10/06

(52) U.S. Cl. CPC G06Q 10/1053; G06Q 10/063112; G06F 17/30867; G06F 17/30554; G06Q 50/10

(57) ABSTRACT

A computer-implemented method includes steps for matching a job seeker with a job referral source that is a friend. A database is compiled comprising a plurality of friends of the job seeker. A job description for each of the plurality of friends is determined and saved to the database. The job description can comprise information regarding the friend's job title, company name, company location, job duties, etc. Each of the plurality of friends can also send an indication regarding an availability of at least one job. The job seeker can search the database to find friends that have indicated the availability of at least one job. The job seeker can be connected to these friends and can find employment through them.

### CROSS-REFERENCE TO RELATED APPLICATIONS

The present application claims the benefit of priority to U.S. Provisional Application Ser. No. 62/121855, filed Feb. 27, 2015, titled “SYSTEM AND METHOD FOR JOB SEARCHING AND REFERRAL,” which is hereby incorporated by reference in its entirety.

### BACKGROUND

The subject technology relates to ways for finding or referring a job to/from a friend, and in particular for connecting a job seeker to a job referral source.

There is a general need for streamlining the job search and referral process and, specifically, for optimizing how job seekers are connected to job referral sources for the purposes of employment, and vice versa.

### SUMMARY

In some implementations, a job seeker can be matched with a job referral source that is a friend, using computing means. A database is compiled comprising a plurality of friends of the job seeker. A job description for each of the plurality of friends is determined and saved to the database. The job description can comprise information regarding the friend's job title, company name, company location, job duties, etc. Each of the plurality of friends can also send an indication regarding an availability of at least one job. The job seeker can search the database to find friends that have indicated the availability of at least one job. The job seeker can be connected to these friends and can find employment through them.

In other implementations, a job referral source can be matched with a friend who is seeking a job. For example, the job referral source can search a database comprising friends of the job referral source who are seeking jobs. The job referral source can use search terms relating to a job description of the job, such as job title, company name, company location, job duties, etc., to generate search results. The job referral source can then be matched with friends based on the results of the search for the purposes of referring the friends to the job.

Particular implementations provide at least the following advantages: a job seeker can find employment through his/her social network; and a job referral source can help friends in his/her social network to find employment.

Details of one or more implementations are set forth in the accompanying drawings and the description below. Other features, aspects, and potential advantages will be apparent from the description and drawings, and from the claims.

### BRIEF DESCRIPTION OF THE DRAWINGS

In the following description, reference is made to the following figures, and in which are shown by way of illustration specific embodiments in which the subject technology may be practiced. It is to be understood that other embodiments may be utilized and changes may be made without departing from the scope of the subject technology.

FIGS. 1A-1F illustrate examples of generated user interfaces (GUIs) for matching job seekers and job referral sources, according to certain aspects of the subject technology.

FIG. 2 illustrates a conceptual diagram for matching job seekers and job referral sources, according to certain aspects of the subject technology.

FIGS. 3A-3F illustrate conceptual diagrams for matching and compensating varying degrees of job seekers and job referral sources, according to certain aspects of the subject technology.

FIG. 4 illustrates an example of a flow diagram for matching a job seeker with a job referral source, according to certain aspects of the subject technology.

FIG. 5 illustrates an example of a flow diagram for matching a job referral source with a job seeker, according to certain aspects of the subject technology.

FIG. 6 illustrates an example networking system that can be used to implement certain aspects of the technology.

The “system” described herein may be implemented on a server or on a computing device. The term “comprising” means “including, but not necessarily limited to”; it specifically indicates open-ended inclusion or membership in a so-described combination, group, series and the like.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and members have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “coupled” is defined as connected, whether directly or indirectly through intervening members, and is not necessarily limited to physical connections. The connection can be such that the objects are permanently connected or releasably connected. The term “substantially” is defined to be essentially conforming to the particular dimension, shape or other word that substantially modifies, such that the member need not be exact. For example, substantially cylindrical means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

The instant disclosure addresses the foregoing need by utilizing a user's social network to help the user find a job from a friend, and/or help the user refer a job to a friend. According to various aspects of the subject technology, methods and systems for accurately matching job seekers with job referral sources are described.

By more accurately matching job seekers with job referral sources through mutual friends in a social network, the probability of finding a job and/or referring a job is increased. For example, companies typically prefer to hire through referral sources already working at the company. This decreases costs associated with going through employment agencies, and increases the likelihood that the new employee will be a good fit at the company. Conversely, a job seeker is more likely to accept an offer of working at the company by virtue of having a friend already working there. Additionally, the job seeker would be more motivated to perform well, so as to not make his/her friend look bad for referring him/her.

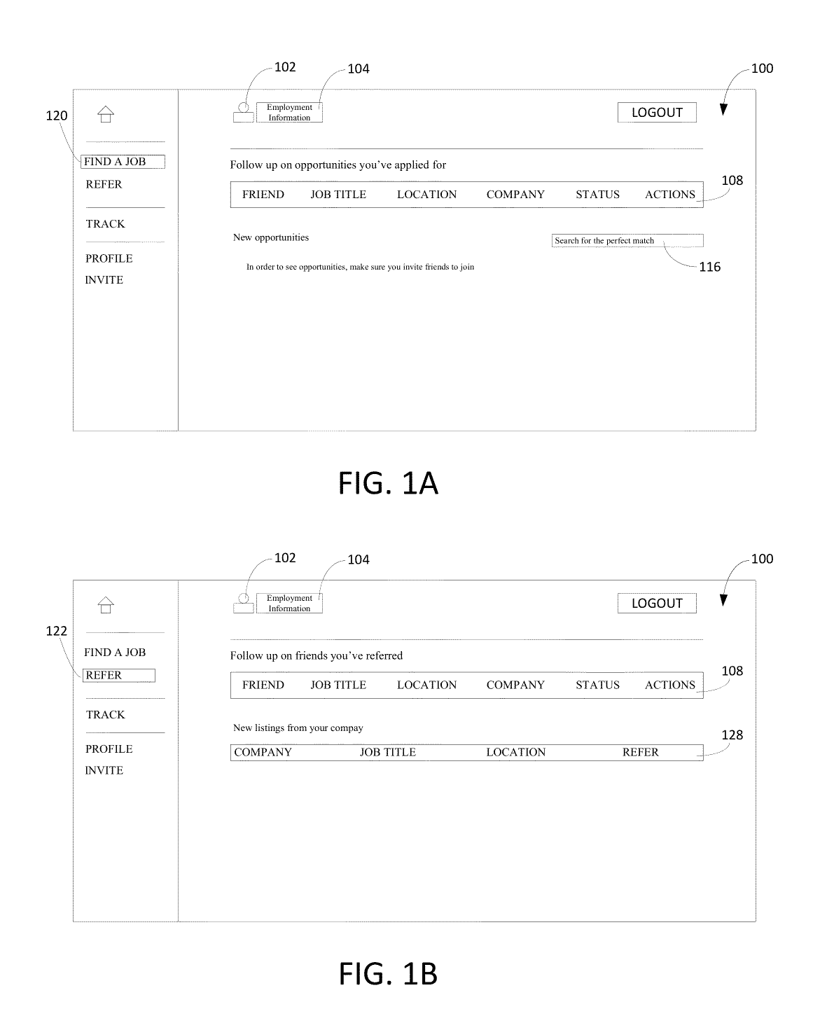

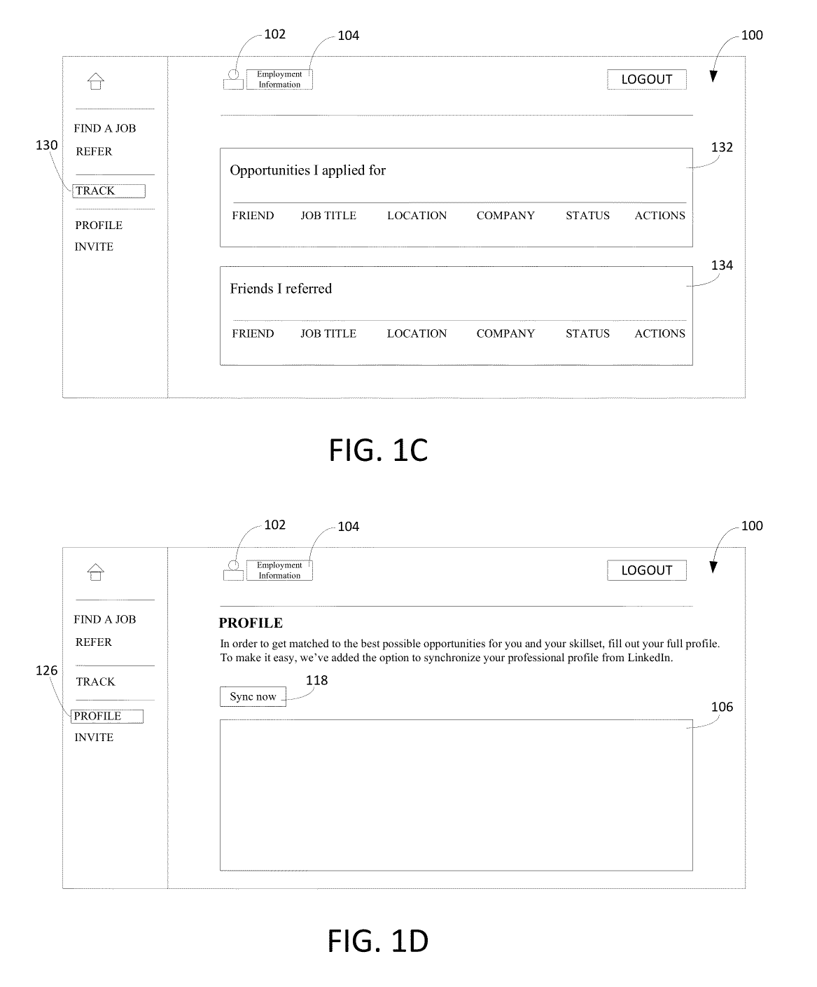

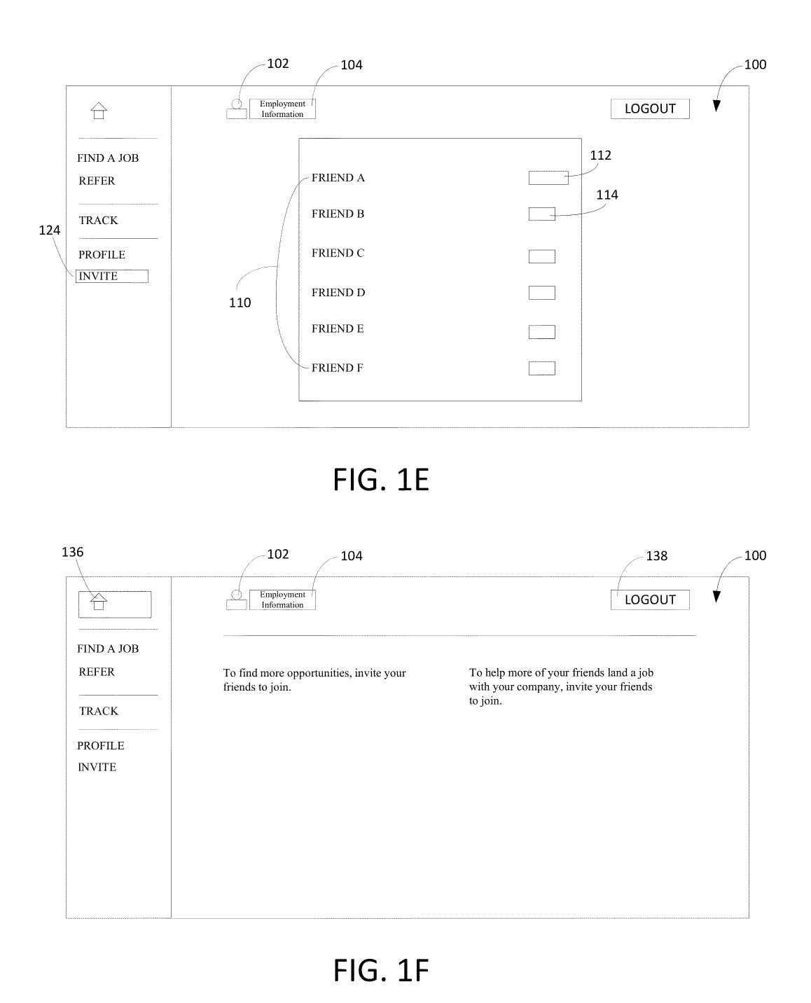

FIGS. 1A-1F illustrate example generated user interfaces (GUIs) 100 for matching job seekers and job referral sources, according to certain aspects of the subject technology. In some implementations, user 102 can securely sign up for, or login to, a server hosted software application. User can use security credentials such as username and password, or use a Facebook, LinkedIn account, or the like, to sign in or log in. In some implementations, user 102 can be a job seeker and/or a job referral source. The server hosted software application can provide a medium for matching user 102 to a job seeker or a job referral source.

The software application can be configured to gather data 104 regarding user 102 and display data 104 on GUI 100. For example, data 104 can comprise job description information 106 regarding user 102, such as job title, company, location, job duties, etc. Job description information 106 can be displayed on GUI 100 in status bar 108. Status bar 108 can provide the status of finding or referring a job.

In some implementations, job description information 106 can be gathered by accessing user's social networking information, such as LinkedIn, Facebook, or other similar service according to means well-known in the art. User 102 can also view and edit user's job description information using profile button 126. In some implementations, user 102 can be prompted upon signing up or logging in to allow the software application to access user's Facebook and LinkedIn accounts to gather information related to user's social network and employment information. For example, social network information can comprise Facebook friends of user 102, and employment information can comprise job description information from user's LinkedIn profile and/or Facebook, or the like. In some implementations, job description information 106 can comprise user's first name, last name, email address, industry sector, position/title, company name, company address, company phone number, personal phone number, and attributes, as shown in FIG. 1D. For example, if user 102 is a patent attorney, attributes can be specific details regarding the user's job, such as, including but not limited to, patent prosecution, legal advice, writing patents, cyberlaw, litigation, appeals, etc. In some implementations, the attributes can be pre-selected from a list so that there is uniformity across all users regarding job description information 106. In other implementations, user 102 can auto-populate job description information 106 using sync button 118. Sync button 118 syncs user's employment information from a social networking source, such as LinkedIn, Facebook, or the like, and auto-populates job description information 106 using information gathered from the social networking source.

In some implementations, user's social networking information can be used to determine potential job seekers and/or potential job referral sources using invite button 124. For example, user's list of friends 110 from Facebook can be imported into the software application. The software application can determine whether friends 110 from the list are registered with the software application. If friends 110 are already registered, then user 102 can be given the option to request a connection with those friends. For example, the request can be accomplished through GUI 100 using a request button 112. If friends 110 are not registered, then user 102 can be prompted to invite those friends to register with the software application. For example, the request can be accomplished through an invite button 114 on GUI. The friends that accept user's requests and invitations can comprise user's referral network. For example, the user's referral network can comprise friends of user 102 that are potential job seekers and/or potential job referral sources.

In some implementations, user 102 can search the referral network using GUI 100. For example, GUI 100 can comprise search box 116. User 102 can use search box 116 to search the referral network for available job seekers and/or job referral sources. User 102 can use search terms that comprise job description information 106, or any other information related to a job, such as base salary or compensation.

In some implementations, user 102 can use GUI 100 to search the referral network to find a job. For example, GUI 100 can comprise job finder button 120. In some implementations, once user 102 toggles job finder button 120, user 120 can be transferred to a tab with search box 116. User 102 can use search box 116 to search the referral network to find a job based on search terms such as job description information 106. In some implementations, job matches can be displayed on GUI 100 on status tab 108. For example, the job matches can comprise the user's friends that have indicated to the software application that a job is available. Clicking on the user's friend matches user 102 to a particular friend with a job opportunity, and a job request is sent to the friend. Status tab 108 can also display previous jobs user 102 applied for through his/her friends, and can display the status and any actions user 102 can take. For example, user 102 can edit, follow-up, accept, or cancel the job request sent to the friend. In some implementations, the software application keeps track of users looking for jobs (i.e., job seekers) and stores to memory which particular job (e.g., using the searched job description information 106) user 102 was looking for. In some implementations, when user 102 selects a match, the selection can cause a message to be sent to the matched friend regarding the user's interest in the job.

In some implementations, user 102 can use GUI 100 to search for friends to refer a job. For example, user 102 can select refer button 122 to toggle an interface (e.g., GUI 100) comprising search box 116. User 102 can use search box 116 to search the referral network to find job seekers seeking a particular job. For example, user 102 can use job description information 106 to determine whether a friend can be matched with user 102 to be referred the job. In some implementations, the software application can use prior search terms used by a job seeker to determine whether to match the job seeker with user 102. For example, user 102 can be matched with the job seeker if user 102 searches similar terms as the job seeker. In some implementations, the matches are displayed on GUI 100 under status bar 108. In some implementations, new listings bar 128 can show new job opportunities for referral. For example, user's company can be linked to the software application, or user 102 can manually update new listings bar 128 with the latest job opportunities. In some implementations, user 102 can indicate that a job is available using new listings bar 128. In some implementations, when user 102 selects a match, the selection can cause a message to be sent to the matched friend regarding the user's interest in referring the friend to the job.

In some implementations, user 102 can track job referrals and/or job opportunities using track tab 130. For example, toggling track tab 130 can navigate user 102 to a page where user 102 can see job opportunities applied for 132 and/or friends referred 134. In some implementations, the more job opportunities successfully applied for, the higher an employment ranking of user 102. For example, the employment ranking can be a numerical determination, such as a percentage, representing how successful user 102 is at applying for jobs (e.g., 9 out of 10 successful job applications for a 90% employment ranking). The employment ranking can determine how high on a search result list user 102 is shown. The higher the employment ranking, the higher up on the list. In other implementations, the more jobs successfully referred, the higher a referral ranking of user 102. For example, the referral ranking can be a numerical determination, such as a percentage, representing how successful user 102 is at referring friends to jobs (e.g., 9 out of 10 successful job referrals for a 90% referral ranking). The referral ranking can determine how high on a search result list user 102 is shown. The higher the referral ranking, the higher up on the list. In some implementations, user's employment ranking and/or referral ranking can be displayed on the search result list on GUI 100. In other implementations, user's employment ranking and/or referral ranking can determine whether user 102 is matched with the job seeker and/or job referral source. For example, if there is too great a disparity (e.g., greater than 50% difference) between employment ranking and/or referral ranking between two people, then user 102 is not matched with the other person.

In some implementations, job seekers and job referral sources can be given a familiarity index (e.g., reliability index) to determine how high on the list to display the job seeker and job referral source. For example, the software application can determine whether job seekers and/or job referral sources that are not within user's primary social network can be considered for jobs. For example, job seekers and job referral sources can be one degree removed, two degrees removed, three degrees removed, etc., up to n degrees removed, from user 102. In some implementations, user 102 can be connected to users up to five degrees removed. Depending on how many degrees removed from user 102, the familiarity index will be “1” for one degree removed, “2” for two degrees removed, “3” for three degrees removed, etc., up to “n” for n degrees removed from user 102. In some implementations, user's familiarity index can determine whether user 102 is matched with the job seeker and/or job referral source. For example, if there is too great a disparity (e.g., greater than three degrees of difference) between familiarity indexes of two people, then user 102 is not matched with the other person. In some implementations, the familiarity index can comprise a reliability index, which takes into account success rate, degree of separation from referral source, etc.

In some implementations, user 102 can toggle home button 136 to see an overview of user's account information. For example, user 102 can invite friends for the purposes of job seeking or job referral. In some implementations, home button 136 can comprise a house-shaped icon. In some implementations, user 102 can log out of the software application using logout button 138. Logout button 138 can be displayed on any page of software application.

In some implementations, everyone can be tracked using means known in the art, including, but not limited to, GPS. For example, user 102 can see where other people are located in real-time. When other people are within a certain distance from user 102, user 102 is notified. In some implementations, the software application can determine that a job seeker is near an available job.

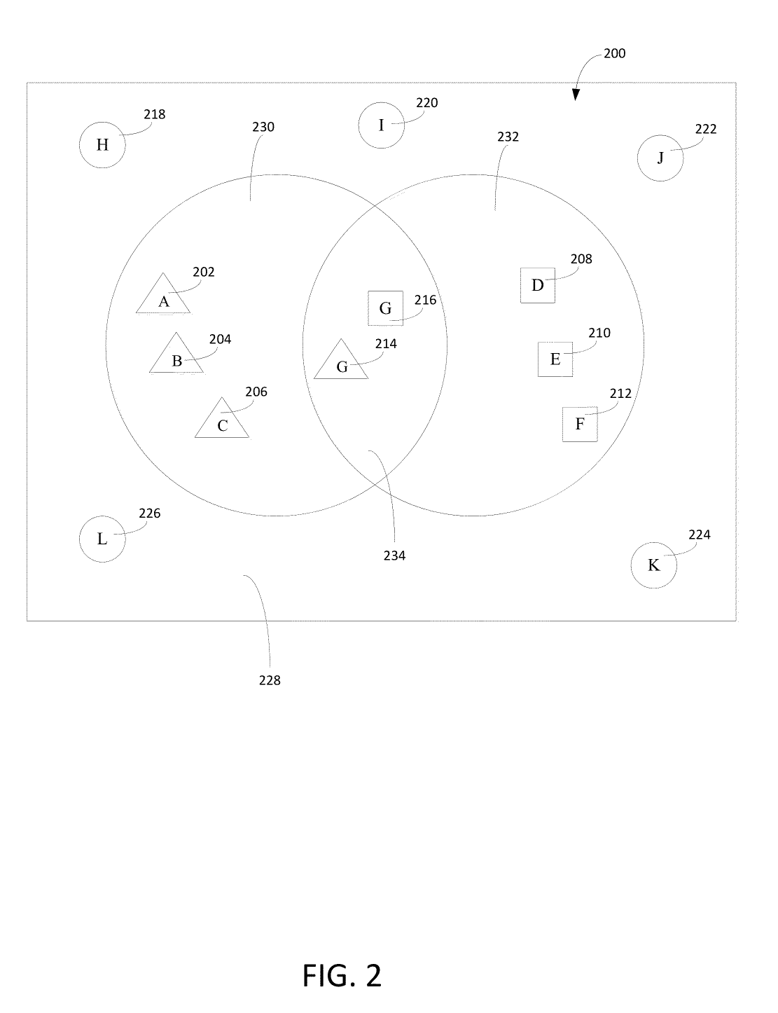

FIG. 2 illustrates a conceptual diagram for matching job seekers and job referral sources, according to certain aspects of the subject technology. In some implementations, a set of users 200 comprises a plurality of friends in social network 228. For example, social network 228 can comprise friends 202-226 which are varying degrees of familiarity apart (e.g., first, second, third, etc.). In some implementations, friends 202-226 can represent a group of similarly situated friends (e.g., friends with similar jobs).

In some implementations, an algorithm can be used to determine how friends are matched with each other for the purposes of job seeking and/or job referrals. For example, friends 202-206 and 214 can represent friends or groups of friends that are job seekers. Friends 208-212 and 216 can represent friends or groups of friends that are job referral sources. The letters indicate a category of job for each friend or group of friends 202-220. For example, in the instant case, friends 202 are in category “A” (e.g., lawyers), friends 204 are in category “B” (e.g., engineers), and friends 206 are in category “C” (e.g., accountants). Friends 202-206 all are designated with a triangle to show interest in finding a job. All friends in job seeking group 230 are designated with a triangle. Similarly, all friends in job referral group 232 are designated with a square and corresponding letter that indicates a different job category (e.g., athlete, producer, writer, etc.).

In some implementations, matched group 234 shows friends or groups of friends that have been matched. For example, friends 214 are job seekers seeking to find job “G” (e.g., dentist). Friends 216 are job referral sources wanting to refer a job “G” to a friend. The algorithm matches friends 214 and 216 because their interests align.

In some implementations, friends 218-226 have signed up for the software application service, but have not yet indicated an interest in finding a job nor an interest in referring a friend for a job. Once friends 218-226 make an indication of being a job seeker or a job referral source, friends 218-226 will be placed into the corresponding group (e.g., job seeking group 230 or job referral group 232). In some implementations, friends 202-226 can be both a job seeker and a job referral source, and hence belong to both job seeking group 230 and job referral group 232. In these cases, the job can be similar or different than the person's current job.

The algorithm as described above can be used in combination with the teachings disclosed herein for the purposes of matching users with referral sources and/or job seekers.

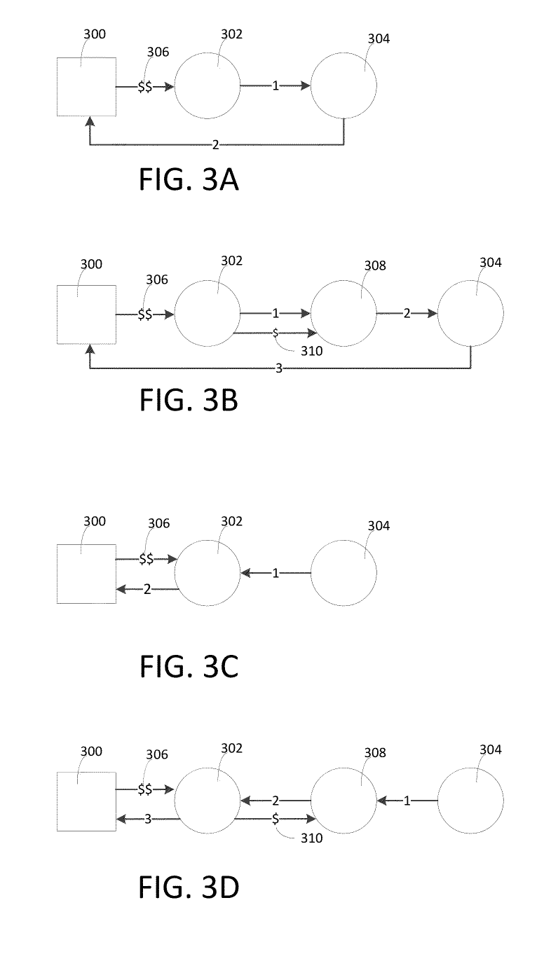

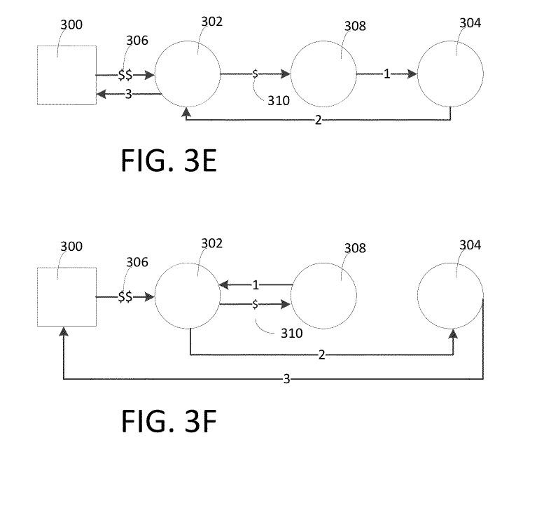

FIGS. 3A-3F illustrate conceptual diagrams for matching and compensating varying degrees of job seekers and job referral sources, according to certain aspects of the subject technology. In some implementations, employer 300 employs employee 302 (e.g., job referral source). Employee 302 can have a friend that is candidate 304 (e.g., job seeker). Employee 302 and candidate 304 can have mutual friend 306, who can be an nth degree acquaintance (e.g., according to the above-description). In some implementations, mutual friend 306 can be given a familiarity index according to the above-description.

Referring to FIG. 3A, in some implementations, employee 302 becomes aware of the availability of a job at employer 300. Employee 302 can then be matched with candidate 304 according to the means above to notify candidate 304 of the availability of the job. Candidate 304 can then be hired by employer 300. In some implementations, employee 302 receives compensation 306 for referring candidate 302 (e.g., finder's fee).

Referring to FIG. 3B, in some implementations, employee 302 can have mutual friend 308. Mutual friend 308 can be friends with both employee 302 and candidate 304. Candidate 304 can learn about the availability of a job at employer 300 through mutual friend 308 according to the means described above. Candidate 302 can then be hired by employer 300. In some implementations, employee 302 receives compensation 306 for referring candidate 304. For example, compensation 306 can be a finder's fee that is paid to employee 302 from employer 300 for finding candidate 304. Additionally, mutual friend 308 can receive referral compensation 310 from employee 302. For example, referral compensation 310 can be a sum less than compensation 306. In some implementations, several mutual friends can be used to link candidate 304 with employee 302. For example, each mutual friend can get a sub-portion of compensation 306 that is divided according to how far they are removed from employee 302.

Referring to FIG. 3C, in some implementations, candidate 304 initiates with employee 302 that candidate 304 is looking for a job. For example, candidate 304 knows that employee 302 works at employer 300 and would also like to work there. Employee 302 notifies employer 300 of candidate's interest. After hiring candidate 304, employer 300 pays employee 302 compensation 306.

Referring to FIG. 3D, in some implementations, candidate 304 initiates searching for a job. Candidate 304 can be connected with employee 302 through mutual friend 308. After hiring candidate 304, employer 300 pays employee compensation 306. In some implementations, referral compensation 310 can be paid to mutual friend 308. For example, referral compensation 310 can be an amount less than compensation 306. In some implementations, several mutual friends can be used to link candidate 304 with employee 302. For example, each mutual friend can get a sub-portion of compensation 306 that is divided according to how far they are removed from employee 302.

Referring to FIG. 3E, in some implementations, mutual friend 308 initiates with candidate 304 to find a job with employer 300. For example, mutual friend knows both employee 302 and candidate 304, but employee 302 and candidate 304 do not know each other. Candidate 304 notifies employee 302 of candidate's interest. After hiring candidate 304, employer 300 pays employee 302 compensation 306, and mutual friend 308 receives referral compensation 310. For example, referral compensation 310 can be an amount less than compensation 306. In some implementations, several mutual friends can be used to link candidate 304 with employee 302. For example, each mutual friend can get a sub-portion of compensation 306 that is divided according to how far they are removed from mutual friend 308.

Referring to FIG. 3F, in some implementations, mutual friend 308 initiates with employee 302 to find candidate 304 a job. Candidate 304 can be connected with employee 302 through mutual friend 308. For example, mutual friend knows both employee 302 and candidate 304, but employee 302 and candidate 304 do not know each other. Employee 302 notifies candidate 304 of the availability of a job at employer 300. After hiring candidate 304, employer 300 pays employee 302 compensation 306, and mutual friend 308 receives referral compensation 310. For example, referral compensation 310 can be an amount less than compensation 306. In some implementations, several mutual friends can be used to link candidate 304 with employee 302. For example, each mutual friend can get a sub-portion of compensation 306 that is divided according to how far they are removed from mutual friend 308.

In some implementations, the process of finding candidate 304 and compensating employee 302 and mutual friend 308 can be performed by the software application described above. For example, an arrangement can be made between employer 300 to use the software application to find candidates. After successful hiring of a candidate, employer 300 pays compensation 306 to the software application. The software application then determines how to distribute compensation 306 depending on how many mutual friends were used to connect employee 302 with candidate 304.

In some implementations, the software application determines who initiated connecting candidate 304 with employee 302, and distributes the compensation accordingly. For example, if employee 302 initiated searching for candidate 304 (as in FIGS. 3A and 3B), then mutual friends closer to employee 302 get more compensation than those more degrees removed from employee 302. If candidate 304 initiated the search (as in FIGS. 3C and 3D), then mutual friends closer to candidate 304 receive more compensation than those more degrees removed from candidate 304. If mutual friend 308 initiated the search (as in FIGS. 3E and 3F), then mutual friends closer to mutual friend 308 receive more compensation than those more degrees removed from mutual friend 308.

The matching of employers to candidates via employees and mutual friends as described above can be implemented using computing means according to the disclosure as set forth herein for job seekers and job referral sources.

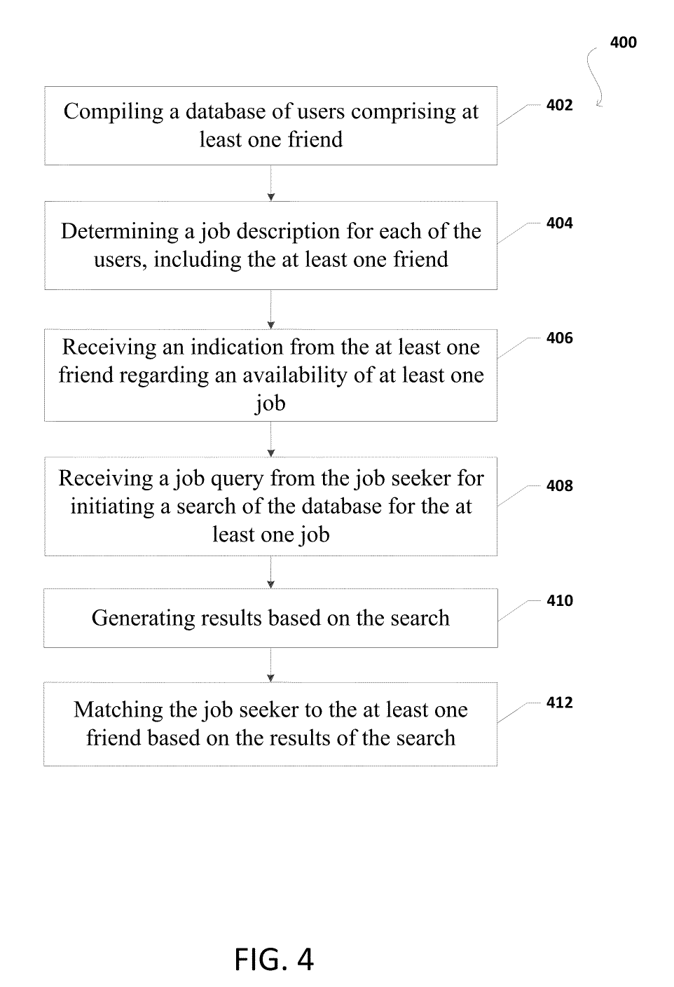

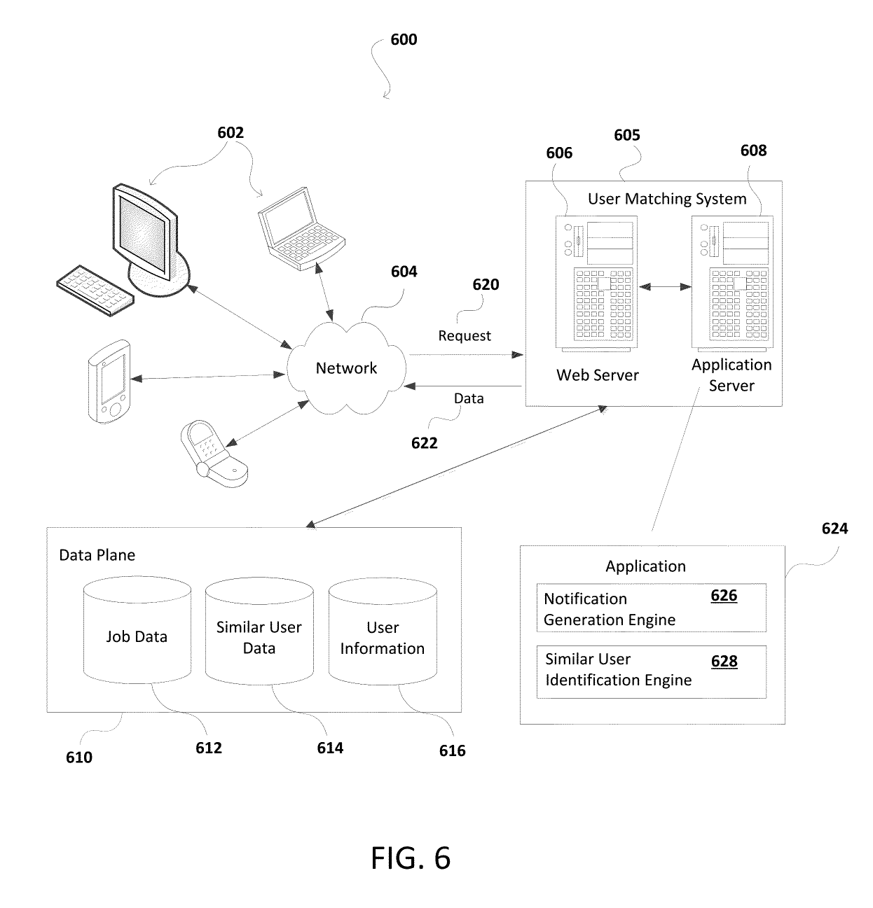

FIG. 4 illustrates an example flow diagram 400 for matching a job seeker with a job referral source, according to certain aspects of the subject technology. The method described below can be carried out using the configurations illustrated in FIGS. 1-3, for example, and various elements of these figures are referenced in explaining the example method. Each block shown in FIG. 4 represents one or more processes, methods or subroutines, for example, which may be implemented entirely, or in part, by a system, such as that illustrated with respect to FIG. 6, discussed in further detail below. Furthermore, the illustrated order of blocks is illustrative only and the order of the blocks can change according to the present disclosure. Additional blocks can be added or fewer blocks may be utilized, without departing from this disclosure. The example method begins at block 402.

At block 402, a database of users is compiled comprising at least one friend.

At block 404, a job description is determined for each of the users, including the at least one friend.

At block 406, an indication is received from the at least one friend regarding an availability of at least one job.

At block 408, a job query is received from a job seeker for initiating a search of the database for the at least one job. For example, the job query can comprise the job description.

At block 410, results are generated based on the search.

At block 412, matching the job seeker is matched to the at least one friend based on the results of the search.

By following the above-described steps, the job seeker can placed in an advantageous position of being hired for the at least one job by virtue of being friends with the at least one friend.

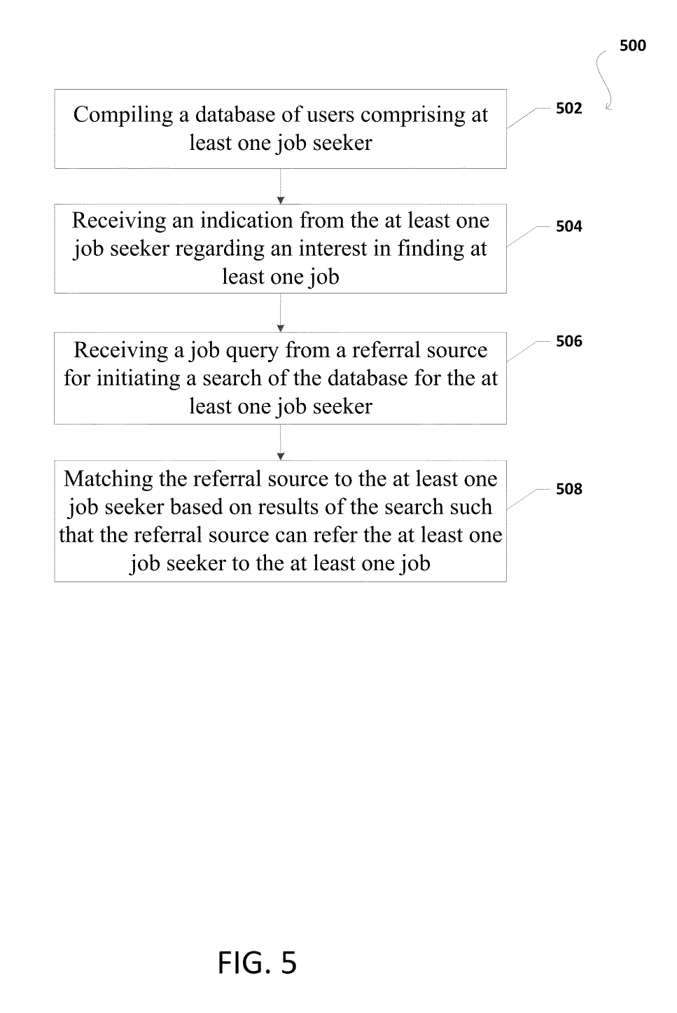

It is understood that the database of users can be saved at a central location or database, or disparately stored across multiple devices, for example in a network. As discussed in further detail with respect to FIG. 5, the database of users can be stored on an application server for future reference/retrieval.

FIG. 5 illustrates an example flow diagram 500 for matching a job referral source with a job seeker, according to certain aspects of the subject technology. The method described below can be carried out using the configurations illustrated in FIGS. 1-3, for example, and various elements of these figures are referenced in explaining the example method. Each block shown in FIG. 5 represents one or more processes, methods or subroutines, for example, which may be implemented entirely, or in part, by a system, such as that illustrated with respect to FIG. 6, discussed in further detail below. Furthermore, the illustrated order of blocks is illustrative only and the order of the blocks can change according to the present disclosure. Additional blocks can be added or fewer blocks may be utilized, without departing from this disclosure. The example method begins at block 502.

At block 502, a database of users is compiled comprising at least one job seeker.

At block 504, an indication is received from the at least one job seeker regarding an interest in finding at least one job.

At block 506, a job query is received from a referral source for initiating a search of the database for the at least one job seeker. For example, the job query can comprise information regarding the at least one job.

At block 508, the referral source can be matched to the at least one job seeker based on results of the search such that the referral source can refer the at least one job seeker to the at least one job.

FIG. 6 illustrates an example networking system 600 that can be used to implement certain aspects of the technology. Although a web-based environment is described for purposes of explanation, different environments may be used, as appropriate, to implement various embodiments.

The example system 600 includes a user matching system 605 and a data plane 610. The user matching system 605 includes at least one web server 606 and at least one application server 608, as described below. The user matching system 605 is an example of a job seeker and/or job referral source selection system implemented as computer programs on one or more computers in one or more locations, in which the systems, components, and techniques described below, can be implemented.

A user can interact with the user matching system 605 through a client device 602. For example, the client device 602 can be a computer coupled to the user matching system 605 through a data communication network 604 (e.g., the Internet). In some instances, the user matching system 605 can be implemented on the client device 602, for example, through a software application executing on the client device 602. The client device 602 generally includes a memory (e.g., a random access memory (RAM)), for storing instructions and data, and a processor for executing stored instructions. The client device 602 can be any appropriate device operable to send and receive requests, messages, or other types of information over the data communication network 604. The client device 602 can also include a display screen though which the user interacting with the client device 602 can view information, (e.g., GUI 100 of FIGS. 1A-1F). Some examples of client devices include personal computers, cellular phones, handheld messaging devices, laptop computers, set-top boxes, personal data assistants, electronic book readers, tablet devices, smartphones and the like.

The data communication network 604 can include any appropriate network, including an intranet, the Internet, a cellular network, a local area network, a wide area network, or any other such network, or combination thereof. Components used for such a system can depend at least in part upon the type of network, the environment selected, or both. Protocols and components for communicating over such a network are well known and will not be discussed herein in detail. The client device 602 can communicate over the data communication network 504 using wired or wireless connections, and combinations thereof.

A user can use the client device 602 to submit a request 620 to log into the user matching system 605. The request 620 can request data representing information relating to job seeking or job referrals. The job seeking data may correspond to information regarding users that are seeking jobs, as described above. The job referrals data may correspond to information regarding users that are seeking to refer jobs, as described above. When the user submits the request 620, the request 620 may be transmitted through the data communication network 604 to the application server 608 within the user matching system 605. The application server 608 responds to the request 620 by using, for example, job data 612, to identify data 622 comprising job matches in response to the request 620. The application server 608 sends the data 622 through the data communication network 604 to the client device 602 for presentation to the user.

The data 622 can include data describing a user interface for responding whether or not the user will select the match. The data 622 can be used, for example, by the client device 602, to select from a list a friend for the purposes of seeking a job or referring a job.

After receiving the data 622 from the application server 608, and through the data communication network 604, a software application, (e.g., web browser or application) 624, running on the client device 602 renders an interactive user matching interface using the data 622. For example, a notification generation engine 626 in the application 624 can generate a notification comprising a message, a statistic, and an indication on a display screen of the client device 602.

In some aspects, the application 624 includes a similar user identification engine 628 that is configured to identify similar users that are seeking similar jobs and/or interested in referring a similar job. In some embodiments, the similar user identification engine 628 is configured to send data relating to similar users to similar user data storage 614.

In some embodiments, the web server 606, the application server 608, and similar components, can be considered to be part of the data plane 610. The handling of all requests and responses, as well as the delivery of content between the client device 602 and the application server 608, can be handled by the web server 606. The web server 606 and the application server 608 are merely example components. However, more or fewer components can be used as structured code can be executed on any appropriate device or host machine as discussed elsewhere herein.

The data plane 610 includes one or more resources, servers, hosts, instances, routers, switches, data stores, other similar components, or a combination thereof. The resources of the data plane 610 are not limited to storing and providing access to data. Indeed, there may be several servers, layers, or other elements, processes, or components, which may be chained or otherwise configured, and which can interact to perform tasks including, for example, obtaining data from an appropriate data store. In some embodiments, the term “data store” refers to any device or combination of devices capable of storing, accessing, and retrieving data, which may include any combination and number of data servers, databases, data storage devices, and data storage media, in any standard, distributed, or clustered environment.

The data stores of the data plane 610 can include several separate data tables, databases, or other data storage mechanisms and media for storing data relating to a particular aspect. For example, the data plane 610 illustrated includes mechanisms for storing resource saving data 612 and user information 616, which can be used to generate the notifications regarding user matches. The data plane 610 is also shown to include a mechanism for storing similar user data 614, which can be used for purposes such as reporting a comparative analysis of how successful users are in seeking and/or referring jobs. The data plane 610 is operable, through logic associated therewith, to receive instructions from the application server 608 and to obtain, update, or otherwise process data, instructions, or other such information in response thereto, as described above.

Each server typically includes an operating system that provides executable program instructions for the general administration and operation of that server, and typically will include a computer-readable medium storing instructions that, when executed by a processor of the server, enable the server to perform its intended functions. Suitable implementations for the operating system and general functionality of the servers are known or commercially available, and are readily implemented by persons having ordinary skill in the art, particularly in light of the disclosure herein.

The environment in one embodiment is a distributed computing environment including several computer systems and components that are interconnected through one or more communication links, using one or more computer networks or direct connections. However, the system described above can be configured to operate equally well using fewer or a greater number of components than are illustrated in FIG. 6. Thus, the system 600 in FIG. 6 is provided merely as one example, and does not limit the scope of the disclosure.

The various embodiments can be implemented in a wide variety of operating environments, which in some cases can include one or more user computers, computing devices, or processing devices which can be used to operate any of a number of applications. User or client devices can include any of a number of general purpose personal computers, such as desktop or laptop computers running a standard operating system, as well as cellular, wireless, and handheld devices running mobile software and capable of supporting a number of networking and messaging protocols. Such a system also can include a number of workstations running any of a variety of commercially-available operating systems and other known applications for purposes such as development and database management. These devices also can include other electronic devices, such as dummy terminals, thin-clients, gaming systems, and other devices capable of communicating via a network.

Various aspects also can be implemented as part of at least one service or Web service, such as may be part of a service-oriented architecture. Services such as Web services can communicate using any appropriate type of messaging, such as by using messages in extensible markup language (XML) format and exchanged using an appropriate protocol such as SOAP (derived from the “Simple Object Access Protocol”). Processes provided or executed by such services can be written in any appropriate language, such as the Web Services Description Language (WSDL). Using a language such as WSDL allows for functionality such as the automated generation of client-side code in various SOAP frameworks.

Most embodiments utilize at least one network that would be familiar to those skilled in the art for supporting communications using any of a variety of commercially-available protocols, such as TCP/IP, OSI, FTP, UPnP, NFS, and CIFS. The network can be, for example, a local area network, a wide-area network, a virtual private network, the Internet, an intranet, an extranet, a public switched telephone network, an infrared network, a wireless network, and any combination thereof.

In embodiments utilizing a Web server, the Web server can run any of a variety of server or mid-tier applications, including HTTP servers, FTP servers, CGI servers, data servers, Java servers, and business map servers. The server(s) also may be capable of executing programs or scripts in response requests from user devices, such as by executing one or more Web applications that may be implemented as one or more scripts or programs written in any programming language, such as Java®, C, C# or C++, or any scripting language, such as Perl, Python, or TCL, as well as combinations thereof. The server(s) may also include database servers, including without limitation those commercially available from Oracle®, Microsoft®, Sybase®, and IBM®.

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (“SAN”) familiar to those skilled in the art. Similarly, any necessary files for performing the functions attributed to the computers, servers, or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch screen, or keypad), and at least one output device (e.g., a display device, printer, or speaker). Such a system may also include one or more storage devices, such as disk drives, optical storage devices, and solid-state storage devices such as random access memory (“RAM”) or read-only memory (“ROM”), as well as removable media devices, memory cards, flash cards, etc.

Such devices also can include a computer-readable storage media reader, a communications device (e.g., a modem, a network card (wireless or wired), an infrared communication device, etc.), and working memory as described above. The computer-readable storage media reader can be connected with, or configured to receive, a computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or Web browser. It should be appreciated that alternate embodiments may have numerous variations from that described above. For example, customized hardware might also be used and/or particular elements might be implemented in hardware, software (including portable software, such as applets), or both. Further, connection to other computing devices such as network input/output devices may be employed.

Storage media and computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules, or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices, or any other medium which can be used to store the desired information and which can be accessed by the a system device. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications, combinations, and changes may be made thereunto without departing from the broader spirit and scope of the disclosure as set forth in the claims.

The description of the subject technology is provided to enable any person skilled in the art to practice the various embodiments described herein. While the subject technology has been particularly described with reference to the various figures and embodiments, it should be understood that these are for illustration purposes only and should not be taken as limiting the scope of the subject technology.

There may be many other ways to implement the subject technology. Various functions and elements described herein may be partitioned differently from those shown without departing from the scope of the subject technology. Various modifications to these embodiments will be readily apparent to those skilled in the art, and generic principles defined herein may be applied to other embodiments. Thus, many changes and modifications may be made to the subject technology, by one having ordinary skill in the art, without departing from the scope of the subject technology.

A reference to an element in the singular is not intended to mean “one and only one” unless specifically stated, but rather “one or more.” The term “some” refers to one or more. Underlined and/or italicized headings and subheadings are used for convenience only, do not limit the subject technology, and are not referred to in connection with the interpretation of the description of the subject technology. All structural and functional equivalents to the elements of the various embodiments described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

What is claimed is:

1. A computer-implemented method for matching a job seeker to at least one job through at least one friend, comprising executing on a processor the steps of:
compiling a database of users comprising the at least one friend;
determining a job description for each of the users, including the at least one friend;
receiving an indication from the at least one friend regarding an availability of the at least one job;
receiving a job query from the job seeker for initiating a search of the database for the at least one job, the job query comprising the job description;
generating results based on the search; and
matching the job seeker to the at least one friend based on the results of the search;
wherein the job seeker is placed in an advantageous position of being hired for the at least one job by virtue of being friends with the at least one friend.

2. The computer-implemented method of claim 1 further comprising:
generating a list of a subset of the users based on the results of the search, the list comprising the at least one friend; and
displaying the list in a generated user interface (GUI) on a display.

3. The computer-implemented method of claim 2 further comprising:
receiving a selection from the job seeker selecting the at least one friend, the selection causing a message to be sent to the at least one friend regarding the job seeker's interest in the at least one job.

4. The computer-implemented method of claim 1 wherein the database of users comprises friends of varying degrees of familiarity with the job seeker.

5. The computer-implemented method of claim 1 wherein a reliability index is associated with each user.

6. The computer-implemented method of claim 5 wherein the reliability index determines whether a user is matched with the job seeker.

7. The computer-implemented method of claim 1 wherein the job description comprises a position title, location, company name, or job duty of the at least one job.

8. A non-transitory computer-readable medium for matching a job seeker to at least one job through at least one friend, comprising instructions stored thereon, that when executed on a processor, perform the steps of:
compiling a database of users comprising the at least one friend;
receiving an indication from the at least one friend regarding an availability of the at least one job;
receiving a job query from the job seeker for initiating a search of the database for the at least one job, the job query comprising information regarding the at least one job; and
matching the job seeker to the at least one job through the at least one friend based on results of the search.

9. The non-transitory computer-readable medium of claim 8 further comprising instructions for:
generating a list of a subset of the users based on the results of the search, the list comprising the at least one friend; and
displaying the list in a generated user interface (GUI) on a display.

10. The non-transitory computer-readable medium of claim 9 further comprising instructions for:
receiving a selection from the job seeker selecting the at least one friend, the selection causing a message to be sent to the at least one friend regarding the job seeker's interest in the at least one job.

11. The non-transitory computer-readable medium of claim 8 wherein the database of users comprises friends of varying degrees of familiarity with the job seeker.

12. The non-transitory computer-readable medium of claim 8 wherein a reliability index is associated with each user.

13. The non-transitory computer-readable medium of claim 12 wherein the reliability index determines whether a user is matched with the job seeker.

14. The non-transitory computer-readable medium of claim 8 wherein the information comprises a position title, location, or company name of the at least one job.

15. A computer-implemented method for referring at least one job to at least one job seeker through a referral source, comprising executing on a processor the steps of:
compiling a database of users comprising the at least one job seeker;
receiving an indication from the at least one job seeker regarding an interest in finding the at least one job;
receiving a job query from the referral source for initiating a search of the database for the at least one job seeker, the job query comprising information regarding the at least one job; and
matching the referral source to the at least one job seeker based on results of the search such that the referral source can refer the at least one job seeker to the at least one job.

16. The computer-implemented method of claim 15 further comprising:
generating a list of a subset of the users based on the results of the search, the list comprising the at least one job seeker; and
displaying the list in a generated user interface (GUI) on a display.

17. The computer-implemented method of claim 16 further comprising:
receiving a selection from the referral source selecting the at least one job seeker, the selection causing a message to be sent to the at least one job seeker regarding the referral source's interest in referring the at least one job seeker to the at least one job.

18. The computer-implemented method of claim 15 wherein the database of users comprises friends of varying degrees of familiarity with the referral source.

19. The computer-implemented method of claim 15 wherein a reliability index is associated with the referral source.

20. The computer-implemented method of claim 19 wherein the reliability index determines whether a user is matched with the referral source.
